(19) United States
(12) Patent Application Publication
(10) Pub. No.: US 2015/0134518 A1
(43) Pub. Date: May 14, 2015

(54) PRE-AUTHORIZED ONLINE CHECKOUT

(71) Applicant: GOOGLE INC., Mountain View, CA (US)

(72) Inventors: Barak Turovsky, Mountain View, CA (US); Estella Chan, Los Altos, CA (US); Scott Roy Atwood, Campbell, CA (US); Stanley N. Marshall, III, Mountain View, CA (US)

(73) Assignee: GOOGLE INC., Mountain View, CA (US)

(21) Appl. No.: 14/080,362

(22) Filed: Nov. 14, 2013

(51) Int. Cl. G06Q 20/36

(52) U.S. Cl. CPC G06Q 20/3674
USPC 705/41

(57) ABSTRACT

A user establishes a digital wallet and registers with and signs in to an authorized application. The user begins a web browsing session, accesses a merchant website, and initiates a transaction using the digital wallet. The user web browser is directed to an authentication page. The user authorizes the transaction and has the option to pre-authorize the merchant for future transactions. The user is redirected to the merchant website and approves the transaction. The transaction is conducted with the virtual credit number created by the payment processing system. The user initiates a subsequent transaction. The digital wallet determines that the previous browsing session is active, the merchant is pre-authorized, and the user is logged into the authorized application. The subsequent transaction is processed without having to be authenticated by the user via the authentication page. Otherwise, the user re-authorizes the merchant via the authentication page before the subsequent transaction proceeds.

### TECHNICAL FIELD

The present disclosure relates generally to online transactions, and more particularly to pre-authorizing an online merchant to conduct transactions.

### BACKGROUND

Online transactions often are conducted with a digital wallet application executing on a user's computing device. A user may configure a digital wallet to interface with a merchant website and to supply payment account information to conduct the transaction. In a typical online transaction using a digital wallet, a web browser or application of the user computing device may be directed away from the merchant website to a website of the payment processing system associated with the digital wallet application. The user may then enter authorization details on the payment processing system website to prevent or reduce fraudulent transactions.

In conventional technology, if the user desires to make another purchase with the merchant at a later time, the authorization process must be repeated. This is an inconvenience to the user and may cause the user to abandon the purchase. Current embodiments do not provide for a pre-authorization of the merchant while maintaining security.

### SUMMARY

In certain example aspects described herein, a computer-implemented method to pre-authorize an online merchant to conduct transactions is provided. A user establishes a digital wallet account and registers with an authorized application. The user signs in to the authorized application. The user begins a web browsing session or selects an application, accesses the website of a merchant, and indicates a desire to conduct a transaction using the digital wallet account. The user web browser is directed to an authentication page where the user authorizes the transaction and pre-authorizes the merchant for future digital wallet transactions. The user is redirected to the website of the merchant, where the user selects an option to approve the transaction based on approval of masked financial account information. Complete financial account information is requested by the merchant system and a virtual credit number is created by the payment processing system and sent to the merchant system. The merchant system processes the transaction using the virtual credit number. The user indicates a desire to conduct a subsequent transaction. The merchant system transmits an inquiry to the digital wallet application module as to whether prerequisite conditions are satisfied. The prerequisite conditions comprise whether the previous browsing session is still active, the merchant is pre-authorized and that the user is logged in to the authorized application. The digital wallet application module determines whether the prerequisite conditions are satisfied and transmits a response to the merchant system. If certain of the prerequisite conditions are satisfied, the user may select to approve the transaction and the transaction is conducted using a new virtual credit number in the same manner as the previous transaction, except that the user does not have to authorize the transaction via the authentication page. If certain of the prerequisite conditions are not satisfied, then the subsequent transaction is conducted using a new virtual credit number in the same manner as the previous transaction.

In certain other example aspects described herein, a system and a computer program product to pre-authorize an online merchant to conduct transactions are provided.

These and other aspects, objects, features, and advantages of the example embodiments will become apparent to those having ordinary skill in the art upon consideration of the following detailed description of illustrated example embodiments.

### BRIEF DESCRIPTION OF THE DRAWINGS

FIG. 1 is a block diagram depicting a system for pre-authorizing an online merchant to conduct transactions, in accordance with certain example embodiments.

FIG. 2 is a block flow diagram depicting a method for pre-authorizing an online merchant to conduct transactions, in accordance with certain example embodiments.

FIG. 3 is a block flow diagram depicting a method for conducting a transaction between a user and an online merchant, in accordance with certain example embodiments.

FIG. 4 is a block flow diagram depicting a method for processing a transaction securely by an online merchant through use of a virtual credit number, in accordance with certain example embodiments.

FIG. 5 is block flow diagram depicting a method for conducting a subsequent transaction between the user and the online merchant, in accordance with certain example embodiments.

FIG. 6 is an illustration of an example user interface of a merchant website, in accordance with certain example embodiments.

FIG. 7 is an illustration of an example user interface of an authentication page of a payment processing system website, in accordance with certain example embodiments.

FIG. 8 is an illustration of an example user interface of a merchant website after pre-authorization, in accordance with certain example embodiments.

FIG. 9 is a block diagram depicting a computer machine and module, in accordance with certain example embodiments.

### DETAILED DESCRIPTION OF EXAMPLE EMBODIMENTS

### Overview

The example embodiments described herein provide methods and systems for pre-authorizing an online merchant to conduct transactions. A merchant is pre-authorized for conducting transactions by a user. When a user utilizes a digital wallet application module to conduct a transaction with an online merchant, the web browser of the user computing device is directed to a website of the payment processing system associated with a digital wallet application module to authorize the transaction. If the user pre-authorizes the merchant, a subsequent transaction may be conducted without directing the web browser to the website of the payment processing system if the user is logged into an authorized application and the web browsing session is still active.

More particularly, in certain example embodiments, the user establishes a digital wallet account. In an example embodiment, a user downloads a digital wallet application module to a user computing device. In an example embodiment, the digital wallet account allows a user to conduct transactions with a merchant using a user computing device via which the user interacts with the digital wallet account. In this same embodiment, the digital wallet application module is an application operating on a user computing device, an account hosted by a payment processing system and accessed with a web browser over the Internet, or any suitable digital wallet embodiment. When accessed by the user computing device, the digital wallet application module communicates with the merchant system to provide account information for conducting a transaction and to conduct the transaction. In an example embodiment, the digital wallet application module stores and utilizes information for any suitable financial account of the user, such as a credit card account, debit card account, stored value account, peer-to-peer transaction account, or any other suitable account. In addition to financial information, the digital wallet application module may store contact information such as a shipping address, an electronic mail address, or a telephone number. In another example embodiment, the user establishes a digital wallet account at the time of purchase and can download the digital wallet application module to the user computing device at that time.

In an example embodiment, the user registers with an authorized application. The authorized application is associated with a provider of the digital wallet application module. For example, the digital wallet application module may be associated with a payment processing system. In an example embodiment, the authorized application is accessible through the web browser from the user computing device. For example, the authorized application may be an account on an email application, a web browser, a payment processing system, a search engine, a file sharing and storage service, a social networking service, an application distribution system, or any suitable application or system. In another example embodiment, the authorized application is an application resident on the user computing device. In an example embodiment, the authorized application is an application that requires the user to sign in or in any other suitable manner to log in. In the example, the email application is associated with the provider of the digital wallet application module. The payment processing system that manages the digital wallet application module may also manage the email application system or otherwise may have access to the sign in status of the user on the email application system.

The user signs into the authorized application. In an example embodiment, the authorized application opens in a separate window or application on the user computing device. In another example embodiment, the authorized application opens as part of the web browser or the digital wallet application module. In an example embodiment, the user signs in by providing authorization information to the authorized application such as a username and a password. In certain embodiments, the user is able to access multiple authorized applications administrated by the digital wallet module provider by entering the authorization information just once.

The user begins a web browsing session. The user may initiate the web browsing session by opening a web browser application or other communication application. In another example embodiment, the user computing device accesses the Internet or otherwise communicates with merchant systems over a network. In another example embodiment, the user selects a merchant application resident on the user computing device to access the merchant's services directly.

The user accesses a website or the application of the merchant system to purchase a product. In an example embodiment, the website is a shopping page, an auction page, a subscription page, a fundraising or charitable donation page, or any suitable merchant website. In another example embodiment, the user accesses the website of the merchant system to review an offer from the merchant system or a third party system to buy a product that the user desires to sell. In another example embodiment, the user accesses a merchant application resident on the user computing device to access the merchant's services directly.

The user conducts a transaction with the merchant using the digital wallet. The user indicates a desire to purchase a product. For example, a “product” may be any tangible or intangible product, as well as a service. In an example embodiment, the user selects a product, adds the product to an electronic shopping cart, and indicates a desire to checkout to complete the purchase of the product. In another example embodiment, the user indicates a desire to accept an offer by the merchant system to purchase the user's product or service. For example, the merchant system has a website that allows users to sell used products or services to the merchant system or to third party systems (with the merchant system acting as a middleman). Any suitable process for requesting a transaction may be utilized.

The web browser of the user computing system is directed to an authentication page. The authentication page may be a website hosted by the payment processing system, the provider of the digital wallet application module, or any other suitable system that can authorize the transaction. The provider of the authentication page will be described herein as the payment processing system. In an example embodiment, the web browser is directed to the authentication page when the user actuates a function to initiate payment. For example, the user clicks a “checkout” button, a “pay now” link, or any suitable button, link, or other control and is navigated to the authentication page as a result.

The user authorizes the transaction and pre-authorizes the merchant website. The authentication page presents an opportunity for the user to pre-authorize future transactions with this merchant. For example, the authentication page may present a button or other interface control object for the user to request the pre-authorization. In another example, the authentication page may present a box to check or any other suitable opportunity. If the user would like to pre-authorize the merchant for a future transaction, then the user indicates his desire by actuating the interface object accordingly. On the authentication page the user may review the merchant name and basic payment details to ensure that the transaction request is not fraudulent. For example, the authentication page may present the user with details about the requested transaction (such as the price, name of the product, and quantity being purchased), the payment information (name of payment device and last four digits of payment number), and shipping information. In an example embodiment, the user chooses which payment device and shipping information he desires to use for the transaction.

The user web browser is redirected to the merchant website. In an example embodiment, the payment processing system provides instructions to the web browser to proceed back to the merchant system webpage after the transaction is authorized and the merchant website is preauthorized. In an example embodiment, the user does not have to preauthorize the merchant website to be redirected to the merchant website to complete the transaction.

The digital wallet application module transmits masked financial account information to merchant system. In another example embodiment, the payment processing system transmits the masked financial account information to the merchant system. In an example embodiment, the masked financial account information corresponds to the user's financial account and is recognizable to the user as corresponding to that account. For example, the masked financial account information may comprise the payment device name, the last four digits of the payment device number, shipping or billing information, and the user's email address. For example, if the payment device name is “Payment Card” and the payment device number is “1234-5678-9012-0000” then the payment device component of the masked financial account information is transmitted as “Payment Card—0000.” In another example, the masked financial information may comprise a code word or other identification that the user would recognize as corresponding to a user financial account. For example, the user entered financial account information on the digital wallet application module or otherwise entered financial account information to a digital wallet account and designated the account “Mr. Smith's Checking” In this same example, the masked payment information may comprise the title that the user gave to the account, “Mr. Smith's Checking” In another example embodiment, the masked financial account information corresponds to a user's proxy account that the user set up with the payment processing system. In an example embodiment, the digital wallet application module transmits the masked financial account information to the merchant system before or at the same time that the user is redirected to the merchant website from the authentication page.

The merchant system receives the masked financial account information. The merchant system displays the masked financial account information on the merchant website. In an example embodiment, the merchant system also displays transaction details such as the purchase order subtotal, the shipping costs, sales tax, and total of the order. In an example embodiment, the user is given the opportunity to change financial account information, shipping information, billing information, cancel the order, and/or place the order.

The user confirms the digital wallet transaction details and financial account information on the merchant website. In an example embodiment, the user actuates an interface object that signals the merchant system to process the order. For example, the user clicks “Place order.”

The merchant system processes the transaction using a virtual credit number. In an example embodiment, the merchant system will use a virtual credit number to process the transaction whether or not the user selects the option to preauthorize the merchant website. A virtual credit number is, for example, a long, randomly generated string to decrease the probability of an unauthorized user obtaining a valid number by means of a brute-force search. A virtual credit number may also be used so that the merchant system can process the transaction without having access to the user's actual payment information. In an example embodiment, the virtual credit number is a one-time use number generated for a specific digital wallet transaction. In another example embodiment, the virtual credit number is an account number corresponding to a user's proxy account. For example, the proxy account is set up by the payment processing system to correspond to a user financial account. In this same example, during a transaction process, the payment processing system debits the user's financial account by communicating with the user's financial institution then credits the merchant account via the proxy account. In yet another example embodiment, the virtual credit number is an actual financial account number, such as a bank account number or a credit account number.

The merchant system requests complete financial account information from the digital wallet account. For example, the merchant system only has access to the masked financial account information and needs complete financial account information to process the transaction. In an example embodiment, the merchant system is unable to process a transaction using only the masked financial account information comprising the payment device name and the last four digits of the payment device number.

The digital wallet application module receives the request for complete financial account information. In another example embodiment, the merchant system requests the complete financial account information from the payment processing system. For example, the payment processing system manages the digital wallet account and has direct access to the complete financial account information.

The digital wallet application module transmits a request for a virtual credit number to the payment processing system. The payment processing system receives the request for the virtual credit number.

The payment processing system assigns a virtual credit number to the digital wallet account. The payment processing system assigns the virtual credit number whether the user has pre-authorized the merchant or not. In an example embodiment, the payment processing system transmits a request for a virtual credit number to the financial institution associated with the payment device selected by the user for use in the digital wallet transaction. In this example embodiment, the user's financial institution assigns a virtual credit number to the user's account and transmits the virtual credit number to the payment processing system.

The payment processing system transmits the virtual credit number to the digital wallet application module. In another example embodiment, the payment processing system transmits the virtual credit number directly to the merchant system.

The digital wallet application module receives the virtual credit number. The digital wallet application module transmits the virtual credit number to the merchant system. The merchant system receives the virtual credit number. Many merchant servers perform additional verification of the client, in case an attacker has obtained the virtual credit number.

The merchant system processes the transaction with the user financial account using the virtual credit number. In an example embodiment, the financial institution assigned the virtual credit number to the user financial account when requested by the digital wallet application module. In another example embodiment, the digital wallet application module assigned the virtual credit number to the user financial account and then communicated this assignment to the user's financial institution. For example, the merchant system communicates with the financial institution associated with the user account to transfer funds from the user account to a merchant account. In this same example, the financial institution associated with the user account recognizes the virtual credit number as being associated with the user account and liberates the transfer of funds from the user account to a merchant system account. In another example, funds from the account associated with the merchant system are moved to the user's account associated with the digital wallet transaction.

The merchant system displays transaction results to the user on the merchant website. In an example embodiment, the user is presented with a summary of the order comprising a list of the items purchased, the total cost of the transaction, shipping information, and a confirmation number.

The user indicates a desire to conduct a subsequent transaction with the merchant system. In an example embodiment, the user navigates away from the merchant system website and returns. In another example embodiment, the user continued shopping on the merchant website. In an example embodiment, the user selects an additional product for purchase and initiates the checkout process. In example embodiments, the analysis for authorization of a subsequent transaction is conducted by the digital wallet application module, the merchant system, the payment processing system, or any suitable party. Actions described herein as being performed by the digital wallet application module may be performed by any suitable party in the respective example embodiment.

The merchant system transmits a prerequisite condition status request to the digital wallet application module. In an example embodiment, prerequisite conditions comprise that the user is using the same browsing session as used in the previous transaction, that the merchant system is pre-authorized for digital wallet transactions, and that the user is logged in to the authorized application. In an example embodiment, if certain of the prerequisite conditions are satisfied, then the user does not have to authorize the transaction via the authentication page. In another example embodiment, the merchant system transmits the prerequisite condition status request to the payment processing system. In an example embodiment, the digital wallet application module (or payment processing system, whichever receives the status request) may communicate with the payment processing system (or the digital wallet application module) and/or the merchant system to respond to the status requests.

The digital wallet application module receives the prerequisite condition status request. In an example embodiment, the digital wallet application module evaluates whether the prerequisite conditions have been satisfied. In an example embodiment, the digital wallet application module makes this evaluation by communicating with the payment processing system or another system. In another example embodiment, the digital wallet application module has direct access to the authorized application login status of the user, the merchant pre-authorization status, and the web browsing session status.

The digital wallet application module determines if the current browsing session is the same browsing session in which the virtual credit number was obtained. If the browsing session is not the same, then the digital wallet application module responds to the merchant system that prerequisite conditions are not satisfied. For example, the current browsing session may not be the same if the user closed the web browsing application and later reopened it.

If the current browsing session is the same, the digital wallet application module determines whether the merchant is pre-authorized. If the merchant is not pre-authorized, then the digital wallet application module responds to the merchant system that prerequisite conditions are not satisfied. For example, if the user declined the option to pre-authorize subsequent transactions with the merchant system during a previous transaction when requested by the authentication page, then the merchant is not pre-authorized.

If the merchant is preauthorized, the digital wallet application module determines whether the user is logged in to the authorized application. If the user is not logged in to the authorized application, then the digital wallet application module responds to the merchant system that prerequisite conditions are not satisfied.

If the user is logged in to the authorized application, the digital wallet application responds to the merchant system that prerequisite conditions are satisfied. In an example embodiment, the merchant system does not acquire user authentication via the authentication page to conduct the subsequent transaction.

In an example embodiment, the subsequent transaction where not all prerequisite conditions are satisfied is conducted in the exact same manner as the previous transaction: the user computing device web browser is directed to an authentication page where the user authorizes the transaction and has the opportunity to pre-authorize the online merchant for future digital wallet transactions, the web browser is re-directed to the merchant website, the merchant system receives masked payment information from the digital wallet and displays it on the merchant website, the user confirms the transaction details and payment information on the website, and the merchant system processes the transaction using a virtual credit number assigned by the payment processing system

In an example embodiment, the subsequent transaction where all prerequisite conditions are satisfied is conducted in the same manner as the previous transaction except that user authorization via the authentication page is bypassed: the merchant system receives masked payment information from the digital wallet and displays it on the merchant website, the user confirms the transaction details and payment information on the website, and the merchant system processes the transaction using a virtual credit number assigned by the payment processing system.

### Example System Architecture

Turning now to the drawings, in which like numerals indicate like (but not necessarily identical) elements throughout the figures, example embodiments are described in detail.

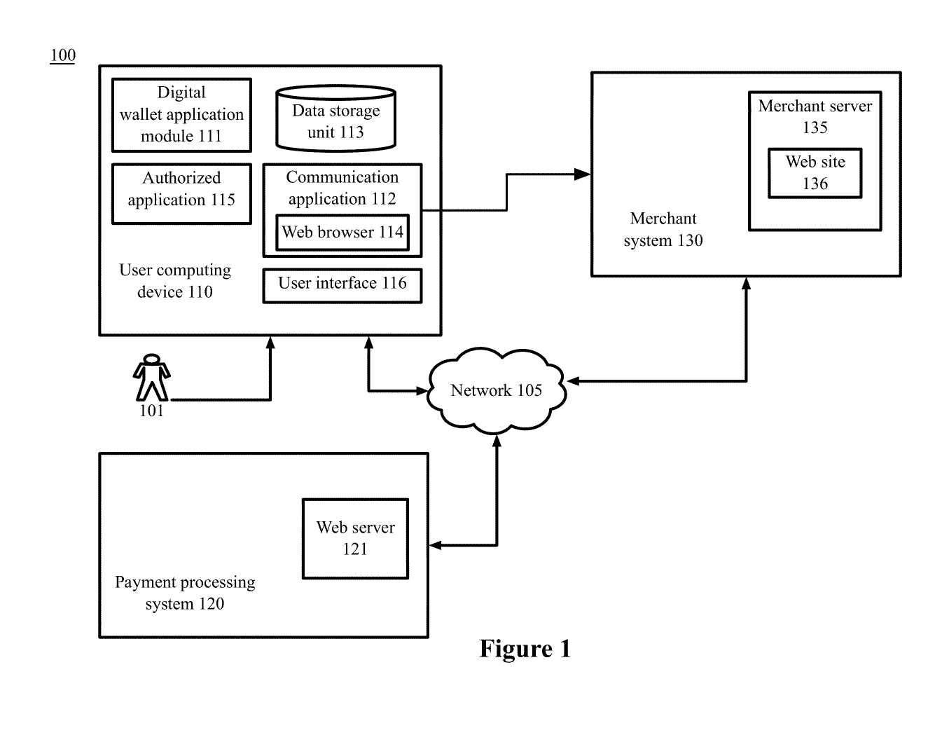

FIG. 1 is a block diagram depicting a system 100 for pre-authorizing an online merchant to conduct transactions, in accordance with certain example embodiments. As depicted in FIG. 1, the system 100 includes network computing devices 110, 120, and 130 that are configured to communicate with one another via one or more networks 105. In some embodiments, a user associated with a device must install an application and/or make a feature selection to obtain the benefits of the techniques described herein.

For example, the network 105 can include a local area network (“LAN”), a wide area network (“WAN”), an intranet, an Internet, storage area network (“SAN”), personal area network (“PAN”), a metropolitan area network (“MAN”), a wireless local area network (“WLAN”), a virtual private network (“VPN”), a cellular or other mobile communication network, Bluetooth, NFC, or any combination thereof or any other appropriate architecture or system that facilitates the communication of signals, data, and/or messages. Throughout the discussion of example embodiments, it should be understood that the terms “data” and “information” are used interchangeably herein to refer to text, images, audio, video, or any other form of information that can exist in a computer-based environment.

Each network computing device 110, 120, and 130 includes a device having a communication module capable of transmitting and receiving data over the network 105. For example, each network computing device 110, 120, and 130 can include a server, desktop computer, laptop computer, tablet computer, a television with one or more processors embedded therein and/or coupled thereto, smart phone, handheld computer, personal digital assistant (“PDA”), or any other wired or wireless, processor-driven device. In the example embodiment depicted in FIG. 1, the network computing devices 110, 120, and 130 are operated by users 101, payment processing system operators (not depicted), and merchant system operators (not depicted), respectively.

An example user computing device 110 comprises a digital wallet application module 111, a data storage unit 113, an authorized application 115, a communication application 112, a web browser application 114, and a user interface 116. In an example embodiment, the digital wallet application module 111 enables a user 101 to store financial account information in order for the user 101 to be able to conduct financial transactions using the user computing device 110.

In an example embodiment, the data storage unit 113 can include any local or remote data storage structure accessible to the user computing device 110 suitable for storing information. In an example embodiment, the data storage unit 113 stores encrypted information, such as HTML5 local storage. In an example embodiment, the data storage unit 113 comprises a secure memory stores the financial account information associated with the digital wallet application module 111.

In an example embodiment, the authorized application 115 is a program, function, routine, applet, or similar entity that exists on and performs its operations on the user computing device 110. In certain embodiments, the user 101 must install the authorized application 115 and/or make a feature selection on the user computing device 110 to obtain the benefits of the techniques described herein. In an example embodiment, the user 101 may access the authorized application 115 on the user computing device 110 via a user interface 116. The authorized application 115 requires the user 101 to authenticate the identify of the user 101. In an example embodiment, the authorized application 115 is an application that requires the user to sign in or in any other suitable manner to log in. In an example embodiment, the user 101 registers with the authorized application 115 by creating an account with the payment processing system 120. In an example embodiment, the user 101 accesses an application distribution site and downloads the authorized application 115 (or multiple authorized applications 115) onto the user computing device 110. In another example embodiment, the user accesses the authorized application 115 through the web browser 114 or other suitable means of access.

In an example embodiment, the user 101 can use a communication application 112, such as a web browser 114 application or a stand-alone application, to view, download, upload, or otherwise access documents or web pages via a distributed network 105.

In an example embodiment, the communication application 112 can interact with web servers or other computing devices connected to the network 105, including the user computing device 110, the web server 121 of the payment processing system 120, and the merchant server 135 of the merchant system 130.

In an example embodiment, the web browser 114 can enable the user 101 to interact with web pages using the user computing device 110. In an example embodiment, the web browser 114 enables the user 101 to view the merchant system's 130 web page and to navigate the web page to select products. In an example embodiment, the web browser 114 also enables the user 101 to interact with the authentication page when the user computing device 110 is redirected there.

In an example embodiment, the user interface 116 enables the user 101 to interact with the web browser 114, the authorized application 115, the digital wallet application module 111, and the communication application 112 on the user computing device 110. For example, the user interface 116 may be a touch screen, a voice-based interface or any other interface, which allows the user 101 to provide input and receive output from an application or module on the user computing device 110. In an example embodiment, the user 101 signs in to the authorized application 115 via the user interface 116. In an example embodiment, the user 101 uses the user interface 116 and the web browser 114 to interact with the merchant website 136.

An example payment processing system 120 comprises a web server 121. In an example embodiment, the web server 121 provides the content that the user 101 accesses through the authorized application 114 on the user computing device 110, including but not limited to html documents, images, style sheets, and scripts. In an example embodiment, the web server 121 supports the payment processing system's 120 authentication page which enables the user 101 to authenticate or pre-authenticate merchant systems 130 for transactions using the digital wallet application module 111. In an example embodiment, the web server 121 also indicates to the payment processing system 120 when or if the user 101 is signed in to the authorized application 115. In an example embodiment, the payment processing system 120 web server 121 assigns a virtual credit number to the merchant system 130 after the user 101 authorizes a transaction.

An example merchant system 130 comprises a merchant server 135 and a web site 136. In an example embodiment, the merchant server 135 is used by the merchant system 130 to administer online transactions between users 101 and the merchant system 130. In an example embodiment, when the user 101 transacts with the merchant system 130 using the digital wallet application module 111, the merchant server 135 communicates with the payment processing system 120 via the network 105 either for merchant authentication or for processing of a transaction. In an example embodiment, the merchant server 135 provides the content for the merchant website 136.

In an example embodiment, the merchant web site 136 displays products for sale by the merchant system 130 for the user 101 view and select via the communication application 112 web browser 114 of the user computing device 110. In an example embodiment, the web site 136 is supported by the merchant server 135.

It will be appreciated that the network connections shown are example and other means of establishing a communications link between the computers and devices can be used. Moreover, those having ordinary skill in the art having the benefit of the present disclosure will appreciate that the user computing device 110, the payment processing system 120, and the merchant system 130 illustrated in FIG. 1 can have any of several other suitable computer system configurations. For example, a user computing device 110 embodied as a mobile phone or handheld computer may or may not include all the components described above.

### Example Processes

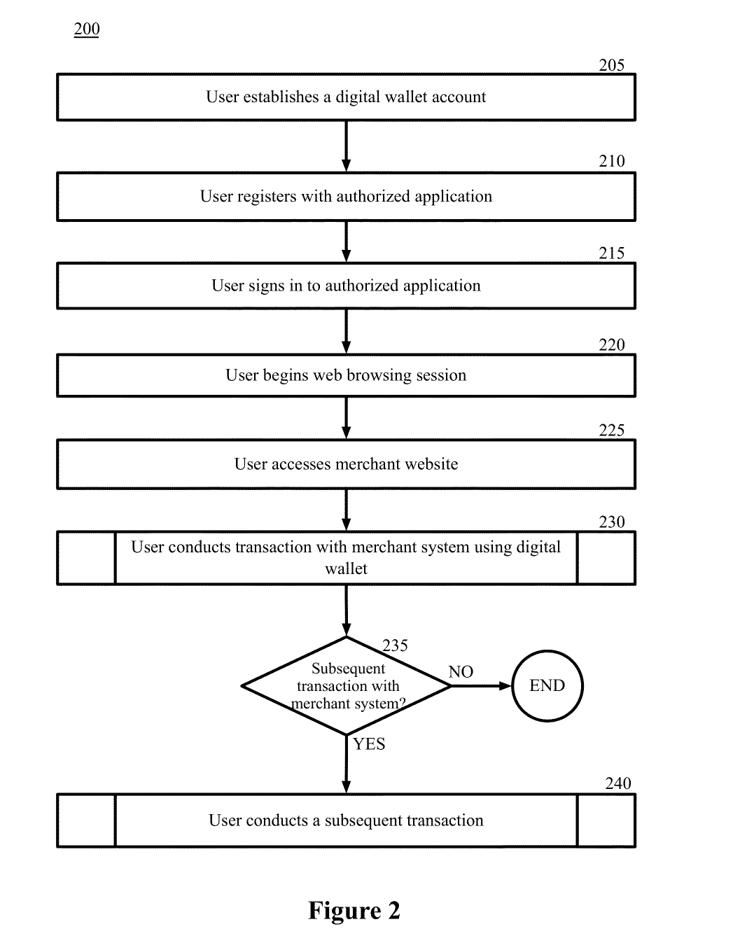

The example methods illustrated in FIGS. 2-5 are described hereinafter with respect to the components of the example operating environment 100. The example methods of FIG. 2-5 may also be performed with other systems and in other environments.

FIG. 2 is a block diagram depicting a method 200 for pre-authorizing an online merchant to conduct transactions, in accordance with certain example embodiments. The method 200 is described with reference to the components illustrated in FIG. 1.

In block 205, the user 101 establishes a digital wallet account. In an example embodiment, registering for the digital wallet account enables the user 101 to download a digital wallet application module 111 to a user computing device 110 for use in transactions. In an example embodiment, the digital wallet application module 111 is created and distributed by the payment processing system 120 for download on the user computing device 110, via which the user interacts with the digital wallet account. In another example embodiment, the digital wallet application module 111 is created and/or distributed by the merchant system 120, a financial system, or another system. In an example embodiment, the user 101 enters financial account information into the digital wallet account or digital wallet application module 111. In an example embodiment, financial account information comprises information associated with a credit card account, debit card account, stored value account, peer-to-peer transaction account, or any other suitable account. In another example embodiment, in addition to financial account information, the digital wallet application module 111 stores contact information such as a shipping address, an electronic mail address, or a telephone number.

In block 210, the user 101 registers with the authorized application 115. In an example embodiment, the authorized application 115 is provided by the same system that provides the digital wallet application module 111, for example, the payment processing system 120. In an example embodiment, the authorized application 115 is an application that requires the user to sign in or in any other suitable manner to log in. In an example embodiment, the user 101 registers with the authorized application 115 by creating an account with the payment processing system 120. In an example embodiment, the user 101 accesses an application distribution site and downloads the authorized application 115 (or multiple authorized applications 115) onto the user computing device 110. In another example embodiment, the user accesses the authorized application 115 through the web browser 114 or other suitable means of access.

In block 215, the user signs in to the authorized application 115. In an example embodiment, the user 101 accesses the authorized application 115 via the web browser 114 of the user computing device 110. In another example embodiment, the user 101 accesses the authorized application 115 directly via the user interface 116 of the user computing device 110. In an example embodiment, the user 101 is capable of accessing multiple authorized applications 115 provided by the payment processing system 120 by signing in one time to one of the authorized applications 115. In an example embodiment, signing in comprises entering a username, password, and/or other identifying information by the registered user 101 of the authorized application 115. In an example embodiment, the authorized application 115 communicates with its provider, the payment processing system 120, via the network 105, to provide services to the user 101.

In block 220, the user 101 begins a web browsing session. In an example embodiment, the user 101 selects and opens a web browser 114 application on the user computing device 110. In another example embodiment, in which the user 101 already signed in to the authorized application 115 using the web browser 114, the user 101, using the web browser 114, opens a new window or opens a new tab of the same window hosting the authorized application 115. In another example embodiment, the user 101 selects a merchant application (not shown) resident on the user computing device 110 to access the merchant's services directly.

In block 225, the user 101 accesses the merchant web site 136. In an example embodiment, the user 101 enters the website 136 address into the address bar of the web browser 114, clicks a link on another website, types in another address and is re-directed, or otherwise arrives at the merchant system 130 website 136. In another example embodiment, the user 101 accesses the merchant system 130 website 136 by selecting another communication application 112 on the user computing device 110. In yet another example embodiment, the user 101 accesses the merchant system 130 website 136 directly via a merchant application (not shown) on the user computing device 110. For example, the merchant system 130 distributes a merchant application that a user 101 can download onto a user computing device 110 and use to communicate purchase orders to the merchant system 130 website 136.

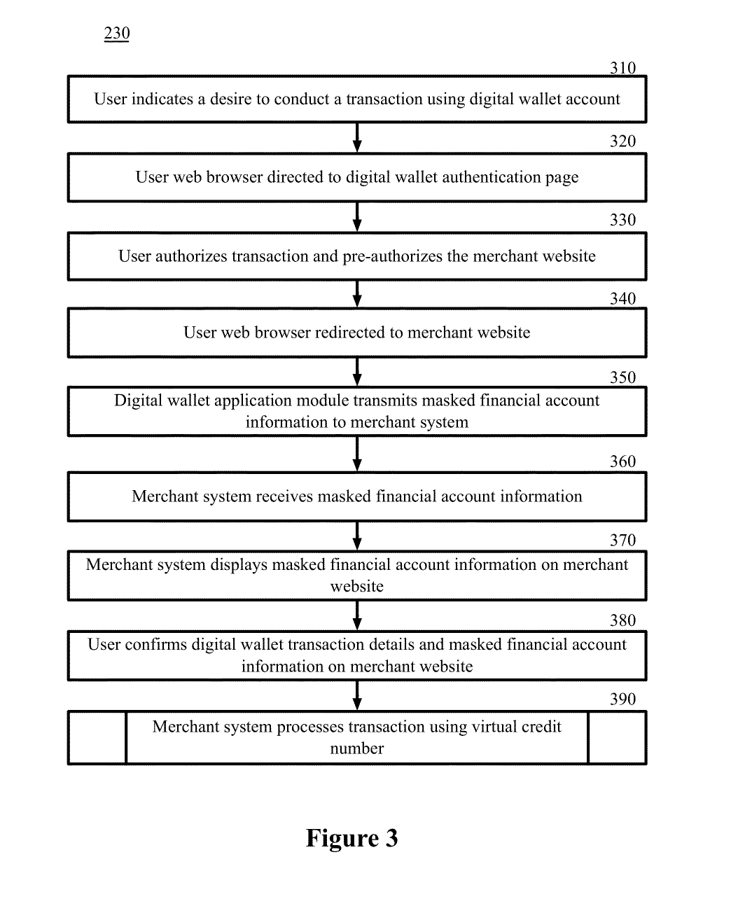

In block 230, the user 101 conducts a transaction with a merchant system 130 using the digital wallet. The method for conducting a transaction with an online merchant system 130 is described in more detail hereinafter with reference to the methods described in FIG. 3.

FIG. 3 is a block flow diagram depicting a method 230 for conducting a transaction with an online merchant system 130, in accordance with certain example embodiments, as referenced in block 230. The method 230 is described with reference to the components illustrated in FIG. 1.

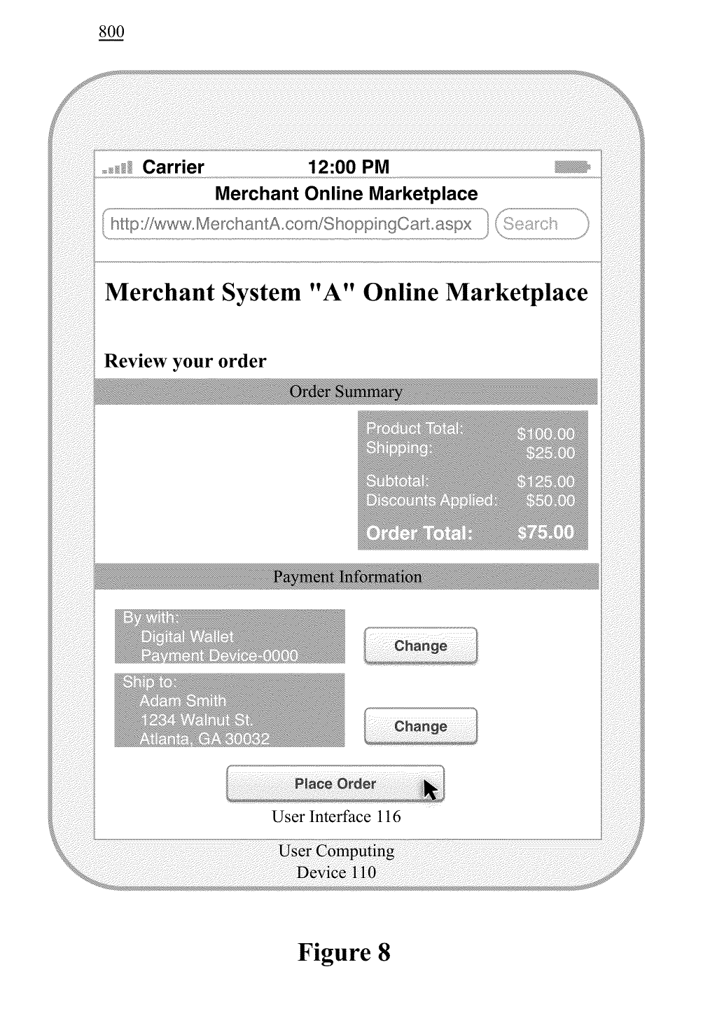

In block 310, the user 101 indicates a desire to conduct a transaction using the digital wallet account. In an example embodiment, the user 101 selects one or more products for purchase from the website 136, adds the products to an electronic shopping cart, and indicates a desire to checkout to complete the purchase of the product. In another example embodiment, the user 101 indicates a desire to accept an offer to buy a product the user 101 wants to sell. In an example embodiment, indicating the desire to checkout using the digital wallet account comprises the user 101 actuating a user interface 116 object. For example, the user 101 actuates an interface object 610 saying “checkout with digital wallet”. In another example embodiment, the user 101 is a returning shopper using the same web browser 114 session and has already pre-authorized the website 136 to allow digital wallet transactions. In this example, illustrated in FIG. 8, the user is presented with an option to “checkout with digital wallet” or “continue checkout” and since there is no authentication necessary, the user 101 can actuate the interface object “continue checkout” and the website 136 will populate the digital wallet account information and initiate the transaction after user 101 approval.

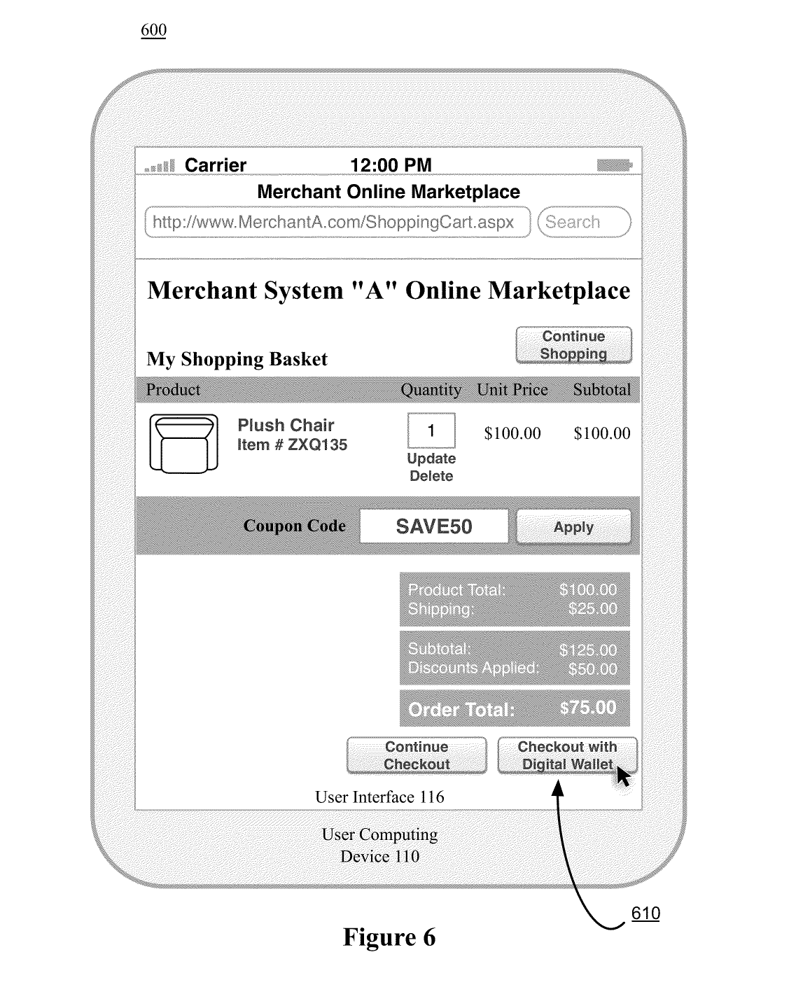

FIG. 6 is an illustration of an example user interface 116 of a merchant website, in accordance with certain example embodiments. The user computing device 110 is shown accessing the merchant web site 136 via the web browser 114. The web browser 114 shows that the user has selected a product for purchase and is presented with the option to actuate an object on the user interface 116 saying “Checkout with Digital Wallet” or “Continue Checkout”.

Returning to FIG. 3, in block 320, the user's 101 web browser 114 is directed to an authentication page. In an example embodiment, the authentication page is administered by the provider of the authorized application 115 and digital wallet application module 111. In an example embodiment, the authentication website is administered by the payment processing system 120. In this embodiment, the payment processing system 120 requires that merchant systems 130 be authorized when users 101 conduct transactions using the digital wallet application module 111 on user computing devices 110. In another example embodiment, the authentication website and the authentication process is administered by a financial system associated with a financial account or by another appropriate system. In an example embodiment, the authentication website is supported by the web server 121 of the payment processing system 120 or other appropriate system. In another example embodiment, the user 101 has already pre-authenticated digital wallet account transactions with the merchant website 136 and is using the same web browser 114 session as a previous purchase. In this example, the user's 101 web browser 114 is directed to a page of the merchant website 136 where the shipping information and digital wallet account information are presented and the user 101 is given the opportunity to approve the transaction. In another example embodiment, the authentication page is within the digital wallet application module 111 resident on the user computing device 110.

In block 330, the user 101 authorizes the transaction and pre-authorizes the merchant website 136. In an example embodiment, the user 101 is requested by the authentication page to authorize the transaction to ensure that the transaction request is not fraudulent. For example, the authentication page may present the user 101 with details about the requested transaction and an opportunity to either cancel the transaction or continue with the transaction. The authentication page may also present the user the opportunity to change shipping and payment information. In an example embodiment, the authentication page presents an opportunity for the user 101 to pre-authorize future transactions with the same merchant system 130 or merchant website 136. For example, the authentication page may present a button or other interface object for the user 101 to request the pre-authorization. In another example, the authentication page may present a box to check or any other suitable opportunity. In the previous examples, if the user would like to pre-authorize the merchant for a future transaction, then the user indicates his desire by actuating the interface object accordingly. In an example embodiment, when a user pre-authorizes the merchant website 136, one or more other websites 136 administered by the merchant system 130 are also pre-authorized.

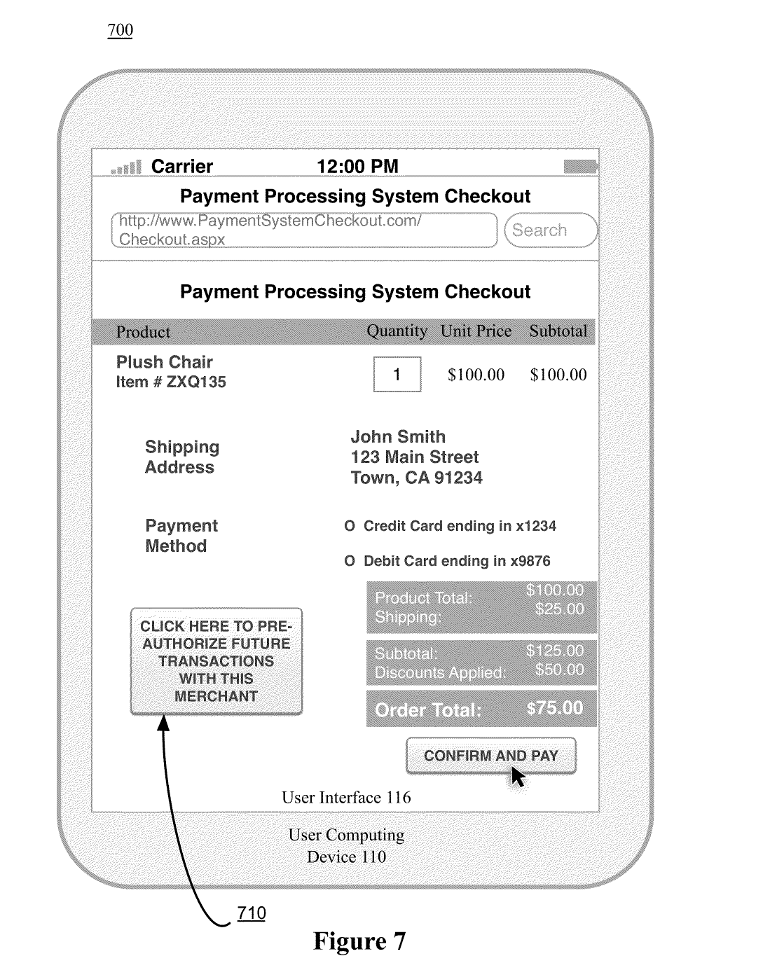

FIG. 7 is an illustration of an example user interface 116 of an authentication page of a payment processing system 120 website, in accordance with certain example embodiments. The user computing device 110 displays the authentication page administered by the payment processing system 120 after the user 101 is re-directed there by the web browser 114. The user 101 is presented with the option to actuate an interface object 710 to “click here to pre-authorize future transactions with this merchant”, or the user 101 may actuate an interface object to “confirm and pay” without preauthorizing.

Returning to FIG. 3, in block 340, the user's 101 web browser 114 is redirected to the merchant web site 136. In an example embodiment, the payment processing system 120 provides instructions to the web browser 114 to proceed back to the merchant system 130 website 136 when the user selects to continue with the transaction. In another example embodiment, instructions are provided to the communication application 112 on the mobile device 110 to navigate to the merchant system 130 web site 136. For example, the user 101 is conducting the transaction using the communication application 112 on the user computing device 112 and not through a web browser 114 of the same device. In this same example, instead of the web browser 114 on the user computing device 110 navigating back to the web site 136, the application on the user computing device 110 navigates to the web site 136 or the merchant's corresponding application.

In block 350, the digital wallet application module 111 transmits masked financial account information to the merchant system 130. In another example embodiment, the payment processing system 120, which manages the digital wallet account, transmits the masked financial account information to the merchant system 130. In an example embodiment, the masked financial account information corresponds to the user's 101 financial account or a user's 101 proxy account and is recognizable to the user as corresponding to that account. In an example embodiment, the masked financial account information comprises the payment device name, the last four digits of the payment device number, the shipping or billing information, and the user's email address. For example, if the payment device name is “Payment Card” and the payment device number is “1234-5678-9012-0000” then the payment device component of the masked financial account information is transmitted as “Payment Card—0000.” In another example, the masked financial information may comprise a code word or other identification that the user 101 would recognize as corresponding to a user 101 financial account. For example, the user 101 entered financial account information on the digital wallet application module 111 or otherwise entered financial account information to a digital wallet account and designated the account “Mr. Smith's Checking.” In this same example, the masked payment information may comprise the title that the user 101 gave to the account, “Mr. Smith's Checking” In another example embodiment, the masked financial account information corresponds to a user's 101 proxy account that the user 101 set up with the payment processing system 120. In an example embodiment, the digital wallet application module 111 or payment processing system 130 transmit the masked financial account information to the merchant system 130 prior to or at the same time that the user is redirected to the merchant web site 136 from the authentication page.

In block 360, the merchant system 130 receives the masked financial account information. For example, the merchant system 130 receives the payment device name and the last four digits of the payment device number.

In block 370, the merchant system 130 displays the masked financial account information on the merchant web site 136. For example, the merchant system 130 displays the payment device name and the last four digits of the payment device number on the merchant web site 136.

In block 380, the user 101 confirms the digital wallet transaction details and masked financial account information on the merchant web site 136. In an example embodiment, the user 101 actuates a user interface 116 object that directs the merchant web site 136 to proceed with the transaction. For example, the user 101 actuates a user interface object that says “Place order.”

FIG. 8 is an illustration of an example user interface 116 of a merchant website, in accordance with certain example embodiments. The user computing device 110 is shown accessing the merchant web site 136 via the web browser 114. The web browser 114 shows that the user has selected a product for purchase and is presented with the option to actuate an object on the user interface 116 saying “place order”. In this example user interface 116 illustration, the user 101 also change the payment device information or shipping information by actuating the respective user interface 116 object that says “Change.”

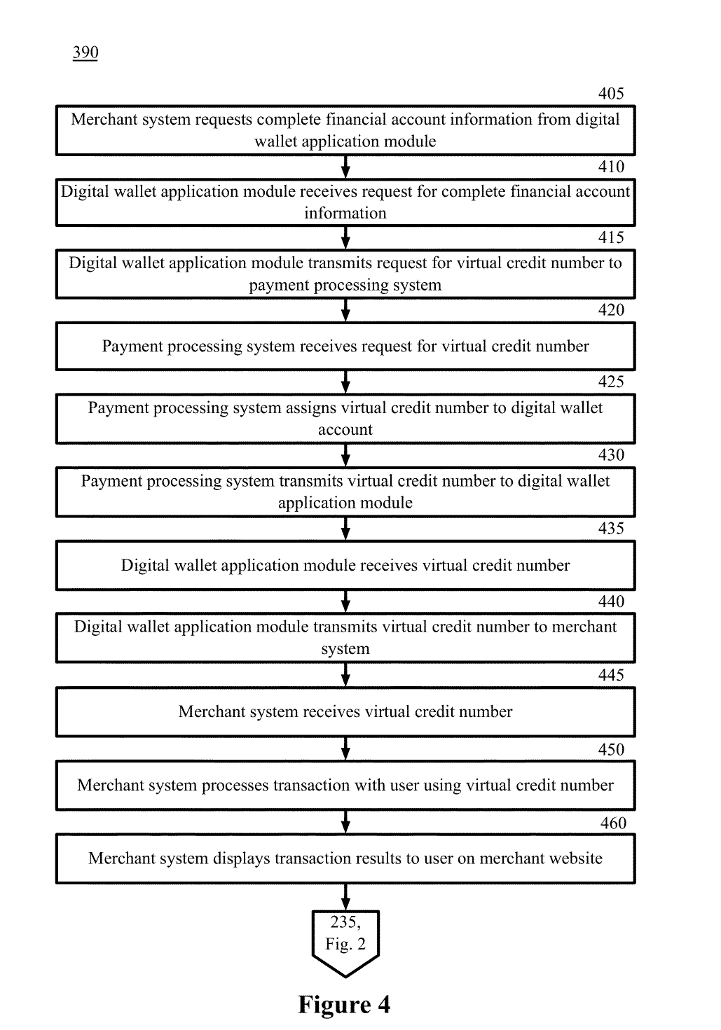

In block 390, the merchant system 130 processes the transaction using a virtual credit number. The method for processing a transaction securely by an online merchant through use of a virtual credit number is described in more detail hereinafter with reference to the methods described in FIG. 4.

FIG. 4 is a block flow diagram depicting a method 390 for processing a transaction securely by an online merchant through use of a virtual credit number, in accordance with certain example embodiments, as referenced in block 390. The method 390 is described with reference to the components illustrated in FIG. 1. In an example embodiment, the virtual credit number is a one-time use number generated for a specific digital wallet transaction. In another example embodiment, the virtual credit number is an account number corresponding to a user's 101 proxy account. For example, the proxy account is set up by the payment processing system 120 to correspond to a user's 101 financial account. In this same example, during a transaction process, the payment processing system 120 debits the user's 101 financial account by communicating with the user's 101 financial institution then credits the merchant account 130 via the proxy account. In yet another example embodiment, the virtual credit number is a user's 101 financial account number, such as a bank account number or a credit account number.

In block 405, the merchant system 130 requests complete financial account information from the digital wallet application module 111. In an example embodiment, the merchant system 130 only has access to the masked financial account information and needs complete financial account information to process the transaction. For example, the merchant system is unable to process a transaction using only the masked financial account information comprising the payment device name and the last four digits of the payment device number. In another example embodiment, the merchant system 130 requests complete financial information from the payment processing system 130, which manages the digital wallet account.

In block 410, the digital wallet application module 111 receives the request for complete financial account information. For example, the merchant system 130 requests the financial account information associated with the user's 101 selected payment device necessary for the merchant system 130 to process the digital wallet transaction.

In block 415, the digital wallet application module 111 transmits a request for a virtual credit number to the payment processing system 120. In an example embodiment, the digital wallet application module 111 transmits this request in response to receiving the request for complete financial information. In an example embodiment, the request for a virtual credit number comprises the financial account information associated with the user's 101 selected payment device for the digital wallet transaction. In another example embodiment, the digital wallet application module 111 does not transmit a request for a virtual credit number to the payment processing system 120, but responds by transmitting financial account information associated with the user's 101 selected payment device for the digital wallet transaction to the merchant system 130.

In block 420, the payment processing system 120 receives the request for a virtual credit number. In an example embodiment, the payment processing system 120 automatically responds to the request for a virtual credit number. In another example embodiment, the payment processing system 120 requests further information from the digital wallet application module 111, the user 101, or the merchant system 130 before issuing the virtual credit number.

In block 425, the payment processing system 120 assigns a virtual credit number to the digital wallet account. In an example embodiment, the payment processing system 120 assigns the virtual credit number whether the user 101 has pre-authorized the online merchant or not. In an example embodiment, the payment processing 120 assigns the virtual credit number to the user's 101 financial account associated with the selected payment device for the digital wallet transaction and then notifies the user's 101 financial institution of the virtual credit number assignment. In another example embodiment, the payment processing system 120 transmits a request for a virtual credit number to the user's 101 financial institution associated with the payment device selected for use in the digital wallet transaction. In this example embodiment, the user's 101 financial institution assigns a virtual credit number to the user's 101 account and transmits the virtual credit number to the payment processing system 120.

In block 430, the payment processing system 120 transmits the virtual credit number to the digital wallet application module 111. In another example embodiment, the payment processing system 120 transmits the virtual credit number to the merchant system 130, responding to the merchant system's 130 request for complete financial account information.

In block 435, the digital wallet application module 111 receives the virtual credit number.

In block 440, the digital wallet application module 111 transmits the virtual credit number to the merchant system 130. In an example embodiment, the digital wallet application module's 111 response to the merchant system's 130 request for complete financial account information comprises transmitting the virtual credit number to the merchant system 130.

In block 445, the merchant system 130 receives the virtual credit number.

In block 450, the merchant system 130 processes the transaction with the user 101 using the virtual credit number. In an example embodiment, the financial institution assigned the virtual credit number to the user 101 financial account when requested by the digital wallet application module 111. In another example embodiment, the digital wallet application module 111 assigned the virtual credit number to the user 101 financial account and then communicated this assignment to the user's 101 financial institution. For example, if the virtual credit number is a one-time use account number assigned by the payment processing system 130 or is a user 101 financial account number corresponding to a user 101 financial institution, the merchant system 130 communicates with the financial institution associated with the user 101 account to transfer funds from the user 101 account to a merchant account. In this same example, the financial institution associated with the user 101 account recognizes the virtual credit number as being associated with the user 101 account and liberates the transfer of funds from the user account to a merchant system 130 account. In another example, if the virtual credit number is a user 101 proxy account number, the merchant system 130 requests funds from the payment processing system 120. The payment processing system 120 communicates with a backing financial institution associated with the proxy account to request an authorization from the backing financial account issuer. The payment processing system 120 receives the authorization and provides an authorization to the merchant system 130 account.

In another example, in which the user 101 has made a sale to the merchant, funds from the account associated with the merchant system 130 are moved to the user's 101 account associated with the digital wallet transaction, either directly or via a user's 101 proxy account with the payment processing system 130. In an example embodiment, the merchant system 130 provides a product to the user 101 as a result of the transaction. For example, the merchant system 130 distributes the product for download on the user computing device 110 or ships a physical product to the user's 101 physical address.

In block 460, the merchant system 130 displays the transaction results to the user 101 on the merchant website 136. In an example embodiment, the merchant system 130 also notifies the payment processing system 120 of the transaction results.

The method 390 for processing a transaction securely by an online merchant through use of virtual credit number ends, the method 230 for conducting a transaction between a user and an online merchant ends, and the method 200 for pre-authorizing an online merchant to conduct transactions proceeds to block 235 in FIG. 2.

Returning to FIG. 2, in block 235, the user determines whether to conduct a subsequent transaction with the merchant system 130. If the user 101 does not conduct a subsequent transaction with the merchant system 130, the method ends.

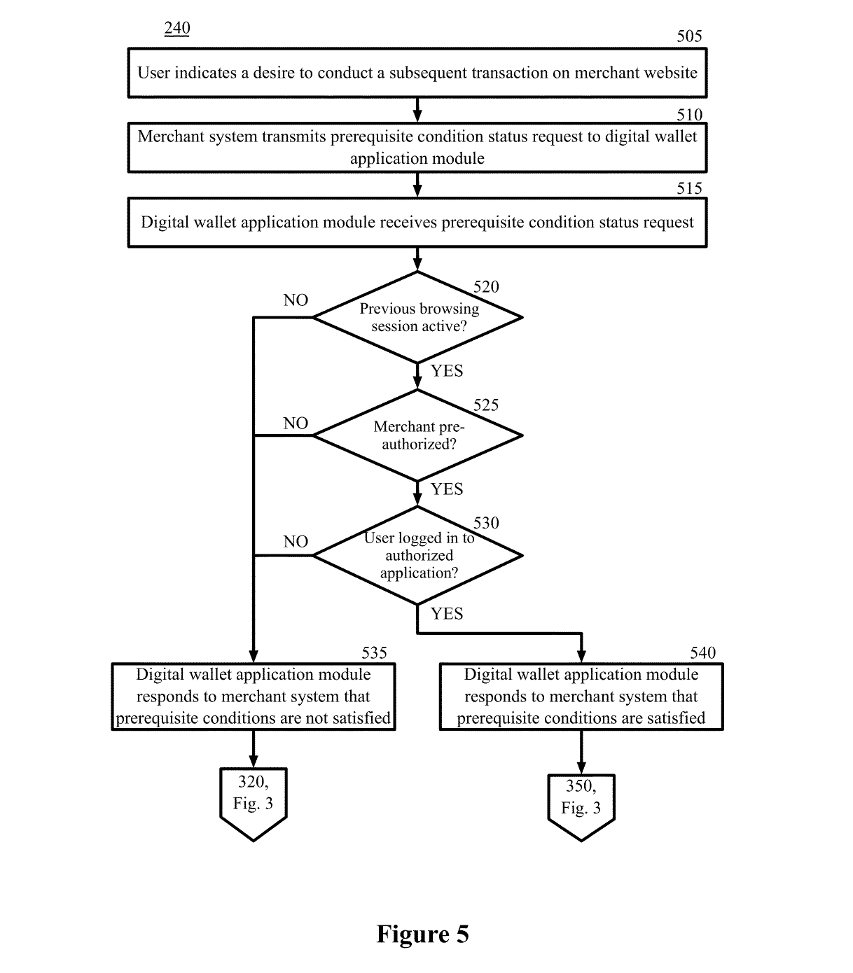

In block 240, if the user 101 decides to conduct a subsequent transaction with the merchant system 130, the user 101 conducts the subsequent transaction. The method for conducting a subsequent transaction between the user 101 and the online merchant system 130 is described in more detail hereinafter with reference to the methods described in FIG. 5.

FIG. 5 is a block flow diagram depicting a method 240 for conducting a subsequent transaction between the user 101 and the online merchant system 130, in accordance with certain example embodiments, as referenced in block 240. The method 240 is described with reference to the components illustrated in FIG. 1.

In block 505, the user 101 indicates a desire to conduct a subsequent transaction on the merchant web site 136. In an example embodiment, the user navigated away from the merchant system 130 website and returned to buy another product. In another example embodiment, the user 101 continued shopping on the merchant website 136. In an example embodiment, the user 101 selects another additional product for purchase and actuates a user interface 116 object to continue checkout or to checkout with the digital wallet. (see FIG. 6 for example user interface 116).

In block 510, the merchant system 130 transmits a prerequisite condition status request to the digital wallet application module 111. In an example embodiment, the prerequisite conditions comprise that the user 101 is using the same browsing session as used in the previous digital wallet transaction, that the merchant system 130 is pre-authorized for digital wallet transactions, and that the user 101 is logged in to the authorized application 115. In an example embodiment, if certain of the prerequisite conditions are fulfilled, the user 101 does not have to authorize the transaction via the authentication page for the merchant system 130 to process the transaction. In another example embodiment, the merchant system 130 transmits the prerequisite condition status request to the payment processing system 120. In an example embodiment, the digital wallet application module 111 or payment processing system 120 (whichever entity receives the status request) may communicate with other entities or systems to respond to the status requests.

In example embodiments, the analysis of the activity of the previous browsing session, the pre-authorization status of the merchant system 130, and the user 101 login status with respect to the authorized application 115 are conducted by the merchant system 130, the digital wallet application module 111, the payment processing system 120, or any suitable party. Actions described herein as being performed by the digital wallet application module 111 may be performed by any suitable party. The order of the analysis of the prerequisite conditions may also be varied. For example, instead of determining first whether the previous browsing session is active, the digital wallet application module 111 may begin by determining whether the user 101 is logged in to the authorization application 115. The analysis of the prerequisite conditions described herein as being performed sequentially may also be performed simultaneously. For example, the digital wallet application module 111 may make a determination that a prerequisite condition is not satisfied yet proceed to determine whether the other prerequisite conditions are met before sending a response to the merchant system 130.

In block 515, the digital wallet application module 111 receives the prerequisite condition status request. In an example embodiment, the digital wallet application module 111 evaluates whether the prerequisite conditions have been satisfied. In an example embodiment, the digital wallet application module 111 evaluates the prerequisite conditions by communicating with the payment processing system 120, the merchant system 130, and/or another system. In another example embodiment, the digital wallet application module 111 has direct access to the authorized application 115 login status of the user 101, the merchant system 130 pre-authorization status, and the web browsing session status.

In block 520, the digital wallet application module 111 determines whether the previous browsing session is active. For example, the digital wallet application module 111 determines whether the browsing session used in the previous purchase has expired or not. For example, the digital wallet application module 111 requests from the web browser 114 the time duration of the current browsing session and compares this time length to the recorded time of the previous transaction to see if the current browsing session existed at the time of the previous transaction. In another example embodiment, the digital wallet application module 111 communicates with the merchant system 130 to make this determination.

If the digital wallet application module 111 determines that the previous browsing session is not active, the method 240 proceeds to block 535.

Returning to block 530, if the digital wallet application module 111 determines that the previous browsing section is active, the method 240 proceeds to block 525 in FIG. 5.

In block 535, the digital wallet application module 111 determines if the merchant has been pre-authorized. For example, a merchant has been pre-authorized if, during a previous transaction, the user 101, using the authentication page, selected to pre-authorize the merchant for subsequent digital wallet transactions. In an example embodiment, the digital wallet application module 111 communicates with the payment processing system 120 to determine if the merchant has been pre-authorized for digital wallet transactions with the user's 101 digital wallet application module 111. In another example embodiment, the digital wallet application module 111 stores a copy of all pre-authorized merchants and accesses the information from a data storage unit. In another example embodiment, the digital wallet application module 111 periodically receives from the payment processing system 120 a list of pre-authorized merchants for digital wallet transactions with the user 101. In this same example embodiment, the digital wallet application module 111 analyzes the list to determine if the merchant's name is on the list. For example, if the merchant's name is on the list of pre-authorized merchant's, the merchant is pre-authorized and, if the merchant's name is not on the list, the merchant is not pre-authorized.

If the digital wallet application module 111 determines that the merchant system 130 has not been pre-authorized, the method 240 proceeds to block 535 in FIG. 5.

Returning to block 535, if the digital wallet application module 111 determines that the merchant system 130 has been pre-authorized, the method 240 proceeds to block 530 in FIG. 5.

In block 530, the digital wallet application module 111 determines if the user 101 is logged in to the authorized application 115. In an example embodiment, the authorized application 115 is provided by the same system that provides the digital wallet application module 111, for example, the payment processing system 120. In an example embodiment, the authorized application 115 is an application that requires the user to sign in or in any other suitable manner to log in. In an example embodiment, the digital wallet application module 111 transmits a user 101 login status request to the payment processing system 120 to ascertain the user's 101 authorized application 115 login status. In another example embodiment, the digital wallet application module 111 and the authorized application 115 communicate on the user computing device 110, allowing the digital wallet application module to directly request, from the authorized application 115 or the user computing device 110, the login status of the user 101. In yet another example embodiment, the digital wallet application module 111 transmits an information request to the web browser 114, the response of which provides information that enables the digital wallet application module 111 to determine the login status of the user 101. In these example embodiments, the appropriate system responds to the request for the login status of the user 101, the digital wallet application module 111 receives the response and makes a determination of the user's 101 login status based on the response.

If the digital wallet application module 111 determines that the user 101 is not logged in to the authorized application 115, the method 240 proceeds to block 535 in FIG. 5.

Returning to block 530, if the digital wallet application module 111 determines that the user 101 is logged in to the authorized application 115, the method 240 proceeds to block 540 in FIG. 5. In this example embodiment, the digital wallet application module 111 determines that all prerequisite conditions are satisfied.

In block 540, the digital wallet application module 111 responds to the merchant system 130 that the prerequisite conditions are satisfied. In another example embodiment, the digital wallet application module 111 proceeds with its role in the digital wallet transaction without transmitting a response to the merchant system 130.

The method 240 then proceeds to block 350 in FIG. 3. The user 101 conducts a transaction with the merchant system 130 using the digital wallet according to applicable portions of method 230. The user 101 does not need to authorize the digital wallet transaction via the authentication page in order for the subsequent transaction to proceed. For example, the merchant system receives masked payment information from the digital wallet application module 111 and displays it on the merchant website 136, the user 101 confirms the transaction details and payment information on the website 136, and the merchant system 130 processes the transaction using a virtual credit number assigned by the payment processing system 120.

In another example embodiment, the method proceeds to block 370 in FIG. 3. In this example embodiment, the merchant system 130 displays the masked financial information on the merchant website 136. For example, the merchant system 130 received the masked financial information from the digital wallet application module 111 during the previous digital wallet transaction and does not need to request the masked financial information again.

Returning to blocks 520, 525, or 530, if the digital wallet application module 111 determines that the previous browsing session is not active (block 520), that the merchant is not pre-authorized (block 525), or that the user is not logged in to the authorized application (block 530), the method 240 proceeds to block 535.

In block 535, the digital wallet application module 111 responds to the merchant system 130 that the prerequisite conditions are not satisfied. In an example embodiment, the response comprises an error message that says that not all prerequisite conditions were satisfied. In another example embodiment, the response comprises an explanation as to a reason or reasons why the prerequisite conditions were not satisfied. For example, the response says “prerequisite conditions not satisfied: the merchant is not pre-authorized. User authorization necessary via the authentication page.”

The method 240 then proceeds to block 320 in FIG. 3. The user 101 conducts a transaction with the merchant system 130 using the digital wallet according to applicable portions of method 230. In this example embodiment, in which not all of the prerequisite conditions are satisfied, the user 101 must authorize the digital wallet transaction via the authentication page in order for the subsequent transaction to proceed. For example, the user computing device 110 web browser 114 is directed to an authentication page where the user 101 authorizes the transaction and has the opportunity to pre-authorize the online merchant for future digital wallet transactions, the web browser 114 is re-directed to the merchant website 136, the merchant system 130 receives masked payment information from the digital wallet application module 111 and displays it on the merchant website 136, the user 101 confirms the transaction details and payment information on the website 136, and the merchant system 130 processes the transaction using a virtual credit number assigned by the payment processing system 120.

### Other Example Embodiments

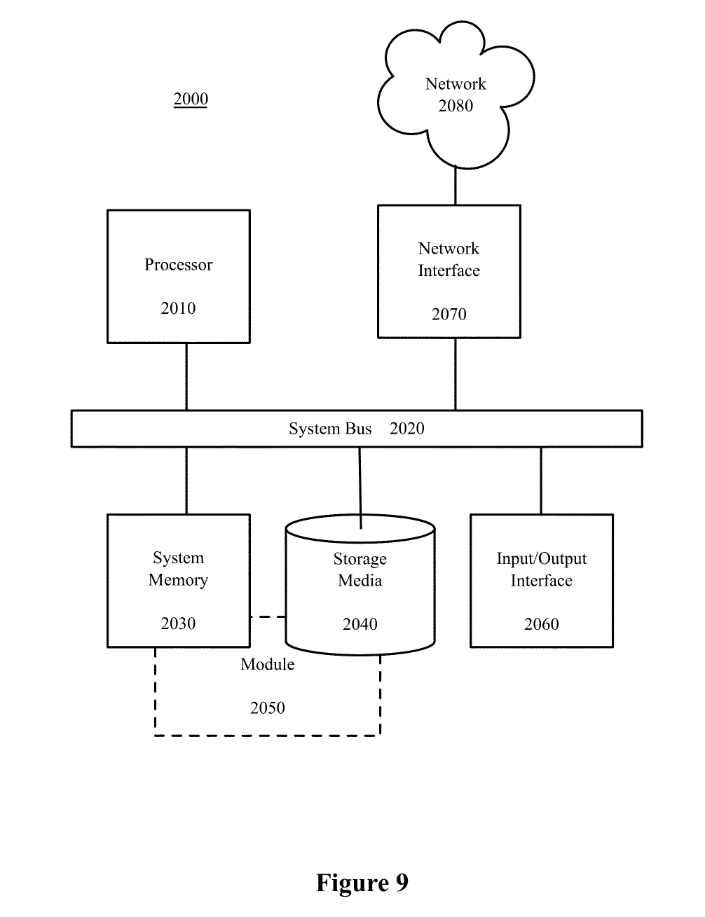

FIG. 9 depicts a computing machine 2000 and a module 2050 in accordance with certain example embodiments. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a set-top box, a kiosk, a vehicular information system, one more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain embodiments, the processor 2010 along with other components of the computing machine 2000 may be a virtualized computing machine executing within one or more other computing machines.

The system memory 2030 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 2030 may also include volatile memories such as random access memory (“RAM”), static random access memory (“SRAM”), dynamic random access memory (“DRAM”), and synchronous dynamic random access memory (“SDRAM”). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device such as the storage media 2040.

The storage media 2040 may include a hard disk, a floppy disk, a compact disc read only memory (“CD-ROM”), a digital versatile disc (“DVD”), a Blu-ray disc, a magnetic tape, a flash memory, other non-volatile memory device, a solid state drive (“SSD”), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (“I/O”) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (WAN), local area networks (LAN), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to some embodiments, any of the processor 2010, the other elements of the computing machine 2000, or the various peripherals discussed herein may be integrated into a single device such as a system on chip (“SOC”), system on package (“SOP”), or ASIC device.

In situations in which the systems discussed here collect personal information about users, or may make use of personal information, the users may be provided with an opportunity or option to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described herein. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the invention claimed herein.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

What is claimed is:

1. A computer-implemented method for pre-authorizing online merchant systems to conduct transactions, comprising:
establishing, by a user computing device, a digital wallet account comprising financial account information of a user, the digital wallet account being associated with a payment processing system;
establishing, by the user computing device, an authorized application associated with the user, wherein establishing the authorized application comprises stored authentication information of the user associated with the authorized application and wherein the authorized application has been accessed by the user;
receiving, by the digital wallet account operating on the user computing device and from the merchant system, a request for user authorization of a digital wallet transaction, wherein the digital wallet transaction is between the user and the merchant system using financial account information from the digital wallet account as the form of payment and is initiated from a browsing session on the user computing device;
requesting, by the digital wallet account operating on the user computing device and from the user, authorization to process a digital wallet transaction;
providing, by the digital wallet account operating on the user computing device, an option to the user to pre-authorize the merchant system for subsequent digital wallet account transactions between the user and the merchant system, wherein the transaction is authorized by the user the merchant website is pre-authorized for subsequent digital wallet transactions;
transmitting, by the digital wallet account operating on the user computing device and from the merchant system, masked financial account information to the merchant system, wherein the masked financial account information comprises partial financial account information such that is identifiable to the user, wherein the merchant system displays the masked financial account information to the user, and wherein the transaction is confirmed by the user;
receiving, by the digital wallet account operating on the user computing device and from the merchant system, a request for complete financial information, wherein the complete financial information comprises information sufficient for the merchant system to process a transaction;
requesting, by the digital wallet account operating on the user computing device and from the payment processing system, a virtual credit number, wherein the virtual credit number is assigned by the payment processing system and wherein the virtual credit number is usable to process a transaction involving the account of the user;
transmitting, by the digital wallet account operating on the user computing device and to the merchant system, in response to the request for complete financial information, the virtual credit number, wherein the merchant system processes the digital wallet transaction using the virtual credit number;
receiving, by the digital wallet account operating on the user computing device and from the merchant system, a prerequisite conditions status request, wherein the prerequisite conditions comprise that the browsing session used in the previous digital wallet transaction is the same as the current browsing session, that the authorization application has been accessed by the user, and that the merchant has been pre-authorized by the user for subsequent digital wallet transactions, and wherein the prerequisite conditions status comprises whether or not the all the prerequisite conditions are satisfied;
determining, by the digital wallet account operating on the user computing device, the prerequisite conditions status; and
transmitting, by the digital wallet account operating on the user computing device and to the merchant system, the prerequisite conditions status.

2. The method of claim 1, wherein the digital wallet transaction is initiated from a web browsing session on the user computing device and wherein the browsing session comprises a web browsing session.

3. The method of claim 1, further comprising:
in response to the merchant system determining that a prerequisite condition has not been satisfied, receiving, by the digital wallet account operating on the user computing device and from the merchant system, a request for user authorization of the subsequent digital wallet transaction;
requesting, by the digital wallet account operating on the user computing device and from the user, authorization to process a digital wallet transaction;
providing, by the digital wallet account operating on the user computing device, an option to the user to pre-authenticate the merchant system for subsequent digital wallet account transactions between the user and the merchant system, wherein the transaction is authorized by the user and the merchant website is pre-authorized for future digital wallet transactions;
transmitting, by the digital wallet account operating on the user computing device and to the merchant system, masked financial account information to the merchant system, wherein the merchant system displays the masked financial account information to the user, and wherein the transaction is confirmed by the user;
receiving, by the digital wallet account operating on the user computing device and from the merchant system, a request for complete financial information;
requesting, by the digital wallet account operating on the user computing device and from the payment processing system, a subsequent virtual credit number; and
transmitting, by the digital wallet account operating on the user computing device and to the merchant system, in response to the request for complete financial information, the subsequent virtual credit number, wherein the merchant system processes the digital wallet transaction using the subsequent virtual credit number.

4. The method of claim 1, further comprising:
in response to the merchant system determining that all prerequisite conditions have been satisfied, transmitting, by the digital wallet account operating on the user computing device and to the merchant system, masked financial account information, wherein the merchant system displays the masked financial account information to the user, and wherein the transaction is confirmed by the user;
receiving, by the digital wallet account operating on the user computing device and from the merchant system, a request for complete financial information;
requesting, by the digital wallet account operating on the user computing device and from the payment processing system, a subsequent virtual credit number; and
transmitting, by the digital wallet account operating on the user computing device and to the merchant system, in response to the request for complete financial information, the subsequent virtual credit number, wherein the merchant system processes the subsequent digital wallet transaction using the subsequent virtual credit number.

5. The method of claim 1, wherein a digital wallet application module comprising the digital wallet account information is downloaded onto the user computing device.

6. The method of claim 1, wherein the authorized application comprises an email account or web browser account.

7. The method of claim 1, wherein the digital wallet transaction is initiated from a service application on the user computing device and wherein the browsing session comprises an application session.

8. The method of claim 1, wherein the authorized application is associated with the payment processing system.

9. The method of claim 1, wherein determining the prerequisite conditions status is performed by the merchant system.

10. A computer program product, comprising:
a non-transitory computer-readable medium having computer-readable program instructions embodied thereon that when executed by a computer cause the computer to pre-authorize online merchant systems to conduct transactions, the computer-readable program instructions comprising:
computer-readable program instructions for receiving, from the merchant system, a request for user authorization of a digital wallet transaction, wherein the digital wallet transaction is between the user and the merchant system using financial account information from a digital wallet account as the form of payment and is initiated from a browsing session on the user computing device, wherein the digital wallet account comprises financial account information of a user, the digital wallet account being associated with a payment processing system;
computer-readable program instructions for requesting, from the user, authorization to process a digital wallet transaction, wherein an authorized application has been accessed by the user;
computer-readable program instructions for providing an option to the user to pre-authorize the merchant system for subsequent digital wallet account transactions between the user and the merchant system, wherein the transaction is authorized by the user the merchant website is pre-authorized for subsequent digital wallet transactions;
computer-readable program instructions for transmitting, from the merchant system, masked financial account information to the merchant system, wherein the masked financial account information comprises partial financial account information such that is identifiable to the user, wherein the merchant system displays the masked financial account information to the user, and wherein the transaction is confirmed by the user;
computer-readable program instructions for receiving, from the merchant system, a request for complete financial information, wherein the complete financial information comprises information sufficient for the merchant system to process a transaction;
computer-readable program instructions for requesting, from the payment processing system, a virtual credit number, wherein the virtual credit number is assigned by the payment processing system and wherein the virtual credit number is usable to process a transaction involving the account of the user;
computer-readable program instructions for transmitting, to the merchant system, in response to the request for complete financial information, the virtual credit number, wherein the merchant system processes the digital wallet transaction using the virtual credit number;
computer-readable program instructions for receiving, from the merchant system, a prerequisite conditions status request, wherein the prerequisite conditions comprise that the browsing session used in the previous digital wallet transaction is the same as the current browsing session, that the authorization application has been accessed by the user, and that the merchant has been pre-authorized by the user for subsequent digital wallet transactions, and wherein the prerequisite conditions status comprises whether or not the all the prerequisite conditions are satisfied;
computer-readable program instructions for determining the prerequisite conditions status; and
computer-readable program instructions for transmitting to the merchant system the prerequisite conditions status.

11. The computer program product of claim 10, further comprising:
computer-readable program instructions for establishing, by a user computing device, a digital wallet account; and
computer-readable program instructions for establishing, by the user computing device, the authorized application associated with the user, wherein establishing the authorized application comprises stored authentication information of the user associated with the authorized application.

12. The computer program product of claim 11, wherein the digital wallet transaction is initiated and authenticated from a web browsing session on the user computing device and wherein the browsing session comprises a web browsing session.

13. The computer program product of claim 11, further comprising, in response to the determining that a prerequisite condition has not been satisfied,
computer-readable program instructions for receiving, from the merchant system, a request for user authorization of the subsequent digital wallet transaction;
computer-readable program instructions for requesting, from the user, authorization to process a digital wallet transaction;
computer-readable program instructions for providing an option to the user to pre-authenticate the merchant system for subsequent digital wallet account transactions between the user and the merchant system, wherein the transaction is authorized by the user and the merchant website is pre-authorized for future digital wallet transactions;
computer-readable program instructions for transmitting, to the merchant system, masked financial account information to the merchant system, wherein the merchant system displays the masked financial account information to the user, and wherein the transaction is confirmed by the user;
computer-readable program instructions for receiving, from the merchant system, a request for complete financial information;
computer-readable program instructions for requesting, from the payment processing system, a subsequent virtual credit number; and
computer-readable program instructions for transmitting, to the merchant system, in response to the request for complete financial information, the subsequent virtual credit number, wherein the merchant system processes the digital wallet transaction using the subsequent virtual credit number.

14. The computer program product of claim 11, further comprising:
in response to the merchant system determining that all prerequisite conditions have been satisfied, computer-readable program instructions for transmitting, to the merchant system, masked financial account information, wherein the merchant system displays the masked financial account information to the user, and wherein the transaction is confirmed by the user;
computer-readable program instructions for receiving, from the merchant system, a request for complete financial information;
computer-readable program instructions for requesting, from the payment processing system, a subsequent virtual credit number; and
computer-readable program instructions for transmitting, to the merchant system, in response to the request for complete financial information, the subsequent virtual credit number, wherein the merchant system processes the subsequent digital wallet transaction using the subsequent virtual credit number.

15. A system for pre-authorizing online merchant systems to conduct transactions, comprising:
a storage device; and
a processor communicatively coupled to the storage device, wherein the processor executes application code instructions that are stored in the storage device to cause the system to:
receive from the merchant system a request for user authorization of a digital wallet transaction, wherein the digital wallet transaction is between the user and the merchant system using financial account information from a digital wallet account as the form of payment and is initiated from a browsing session on the user computing device, wherein an authorized application has been accessed by the user;
request from the user authorization to process a digital wallet transaction;
provide an option to the user to pre-authorize the merchant system for subsequent digital wallet account transactions between the user and the merchant system, wherein the transaction is authorized by the user the merchant website is pre-authorized for subsequent digital wallet transactions;
transmit from the merchant system masked financial account information to the merchant system, wherein the masked financial account information comprises partial financial account information such that is identifiable to the user, wherein the merchant system displays the masked financial account information to the user, and wherein the transaction is confirmed by the user;
receive from the merchant system a request for complete financial information, wherein the complete financial information comprises information sufficient for the merchant system to process a transaction;
request from the payment processing system a virtual credit number, wherein the virtual credit number is assigned by the payment processing system and wherein the virtual credit number is usable to process a transaction involving the account of the user;
transmit to the merchant system in response to the request for complete financial information, the virtual credit number, wherein the merchant system processes the digital wallet transaction using the virtual credit number;
receive from the merchant system a prerequisite conditions status request, wherein the prerequisite conditions comprise that the browsing session used in the previous digital wallet transaction is the same as the current browsing session, that the authorization application has been accessed by the user, and that the merchant has been pre-authorized by the user for subsequent digital wallet transactions, and wherein the prerequisite conditions status comprises whether or not the all the prerequisite conditions are satisfied;
determine the prerequisite conditions status; and
transmit to the merchant system, the prerequisite conditions status.

16. The system of claim 15, wherein the digital wallet transaction is initiated and authenticated from a web browsing session on the user computing device and wherein the browsing session comprises a web browsing session.

17. The system of claim 15, wherein the processor is further configured to execute computer-executable instructions stored in the storage medium to cause the system to:
establish the digital wallet account comprising financial account information of a user, the digital wallet account being associated with a payment processing system; and
establish the authorized application associated with the user, wherein establishing the authorized application comprises stored authentication information of the user associated with the authorized application.

18. The system of claim 15, wherein the processor is further configured to execute computer-executable instructions stored in the storage medium to cause the system to:
in response to the merchant system determining that a prerequisite condition has not been satisfied, receive from the merchant system a request for user authorization of the subsequent digital wallet transaction;
request from the user authorization to process a digital wallet transaction;
provide an option to the user to pre-authenticate the merchant system for subsequent digital wallet account transactions between the user and the merchant system, wherein the transaction is authorized by the user and the merchant website is pre-authorized for future digital wallet transactions;
transmit to the merchant system masked financial account information to the merchant system, wherein the merchant system displays the masked financial account information to the user, and wherein the transaction is confirmed by the user;
receive from the merchant system a request for complete financial information;
request from the payment processing system a subsequent virtual credit number; and
transmit to the merchant system in response to the request for complete financial information, the subsequent virtual credit number, wherein the merchant system processes the digital wallet transaction using the subsequent virtual credit number.

19. The system of claim 15, wherein the processor is further configured to execute computer-executable instructions stored in the storage medium to cause the system to:
transmit, in response to the merchant system determining that all prerequisite conditions have been satisfied to the merchant system masked financial account information, wherein the merchant system displays the masked financial account information to the user, and wherein the transaction is confirmed by the user;
receive from the merchant system a request for complete financial information;
request from the payment processing system a subsequent virtual credit number; and
transmit to the merchant system in response to the request for complete financial information, the subsequent virtual credit number, wherein the merchant system processes the subsequent digital wallet transaction using the subsequent virtual credit.

20. The system of claim 15, wherein the digital wallet transaction is initiated and authenticated from a service application on the user computing device and wherein the browsing session comprises an application session.
